(19) United States
(12) Patent Application Publication
(10) Pub. No.: US 2003/0155386 A1
(43) Pub. Date: Aug. 21, 2003

(54) Connector for a reservoir

(76) Inventor: Ming-Yu Lai, Taichung Hsien (TW)

Correspondence Address: VENABLE, BAETJER, HOWARD AND CIVILETTI, LLP, P.O. BOX 34385, WASHINGTON, DC, 20043-9998, US

(21) Appl. No.: 10/075,374

(22) Filed: Feb. 15, 2002

(51) Int. Cl. B67D 3/00

(52) U.S. Cl. 222/564

(57) ABSTRACT

A connector for a reservoir has a body and a guiding member. A passage is defined through the body and communicates with the reservoir. The guiding member is mounted in the passage and has a post and multiple spiral leaves. Accordingly, a vortex flow will be caused as the fluid passes through the guiding member. This can prevent stagnant areas forming in the fluid, and thus germ-breeding areas are eliminated. In addition, the post will abut against the diaphragm of the reservoir to avoid the diaphragm being pushed into the passage when the water chamber of the reservoir is empty. This can ensure that the fluid can be pumped efficiently into the reservoir, and the useful life of the reservoir is prolonged.

### BACKGROUND OF THE INVENTION

1. Field of the Invention

The present invention relates to a connector, and more particularly to a connector for a reservoir and with a guiding member to cause a vortex flow in the reservoir as the fluid is pumped into the reservoir.

2. Description of Related Art

With reference to FIG. 7, a reservoir for a drinking water dispenser comprises a metal shell (50), a plastic lining (53), a diaphragm (51) and a connector (52). The lining (53) is mounted in the shell (50). The diaphragm (51) is mounted in a middle position of the shell (50) so as to divide the shell (50) into an air cushion between the shell (50) and the diaphragm (51) and a water chamber between the lining (53) and the diaphragm (51). The connector (52) extends through both the shell (50) and the lining (53). A passage is defined through the connector (52) and communicates with the water chamber to allow the fluid to flow into or out of the water chamber. The air cushion can exert pressure on the fluid stored in the water chamber to cause the fluid to flow out of the connector (52).

However, most of the fluid stored in the water chamber is virtually stationary except the fluid near the connector (52) as the fluid is pumped into the reservoir, and it is found that this stagnant water becomes a breeding ground for germs. Thus, the fluid stored in the reservoir for a long time is not healthy for anyone drinking at the water dispenser.

In addition, when the water chamber is empty, the diaphragm (51) will be pushed to abut the connector (52) due to the high pressure in the air cushion. When the passage of the connector (52) has a large diameter, part of the diaphragm (51) will be pushed into the passage in the connector (52) as shown in the phantom lines in the figure. This will block the fluid from flowing into the water chamber through the connector (52). The resiliency of the diaphragm (51) is easily lost due to the deformation of the diaphragm (51) and the useful life of the diaphragm (51) is thus shortened.

To overcome the shortcomings, the present invention tends to provide a connector to mitigate or obviate the aforementioned problems.

### SUMMARY OF THE INVENTION

The main objective of the invention is to provide a connector with a guiding member that can cause a vortex flow in the reservoir as the fluid passes through the guiding member. The connector has a body and a guiding member. A passage is defined through the body and communicates with the reservoir. The guiding member is mounted in the passage of the body and has a post and multiple spiral leaves. The leaves extend outward from the outer periphery of the post. A vortex flow will be caused as the fluid passes through the leaves. This can prevent unhealthy stagnant portions forming in the fluid in the reservoir and the sanitary condition of a water dispenser fitted with the connector is improved.

Another objective of the invention is to provide a connector with a guiding member to abut the diaphragm of the reservoir to avoid part of the diaphragm being pushed into the passage of the connector as the water chamber is empty. This can ensure that the fluid can be pumped into the reservoir, and the useful life of the reservoir is prolonged.

Other objects, advantages and novel features of the invention will become more apparent from the following detailed description when taken in conjunction with the accompanying drawings.

### BRIEF DESCRIPTION OF THE DRAWINGS

FIG. 1 is an operational side plan view of a reservoir with a connector in accordance with the present invention;

FIG. 2 is a side plan view in partial section of the connector in accordance with the present invention;

FIG. 3 is a bottom plan view of the connector in FIG. 2;

FIG. 4 is a perspective view of the guiding member of the connector in FIG. 2;

FIG. 5 is an operational plan view in partial section of the connector in FIG. 2;

FIG. 6 is an operational plan view in partial section of the reservoir with the connector in FIG. 2; and

FIG. 7 is an operational plan view in cross section of the reservoir with a conventional connector in accordance with prior art.

### DETAILED DESCRIPTION OF PREFERRED EMBODIMENT

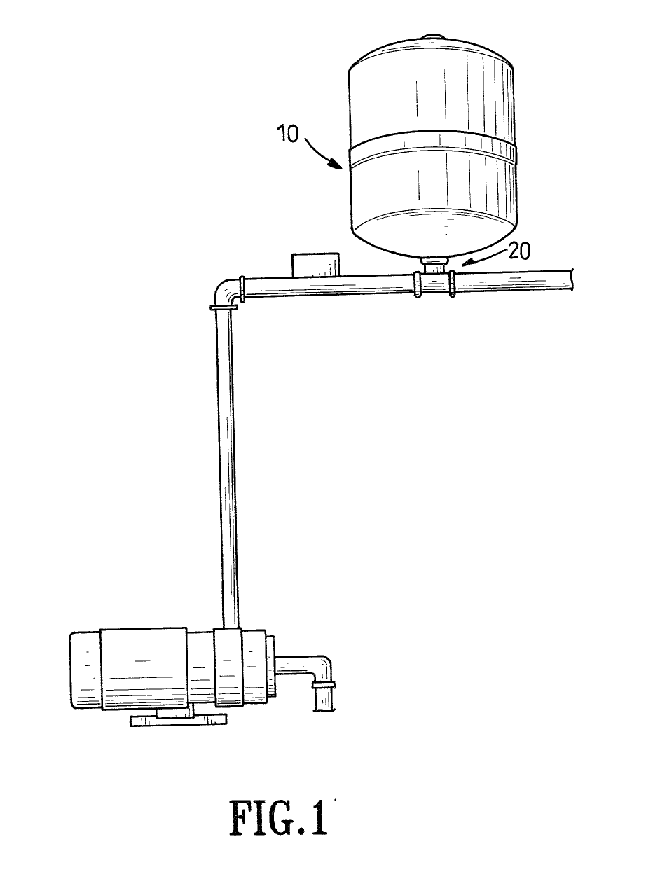

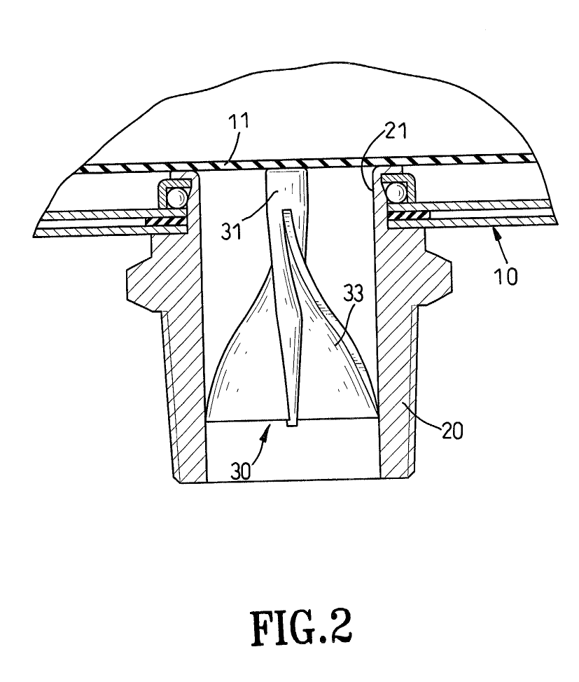

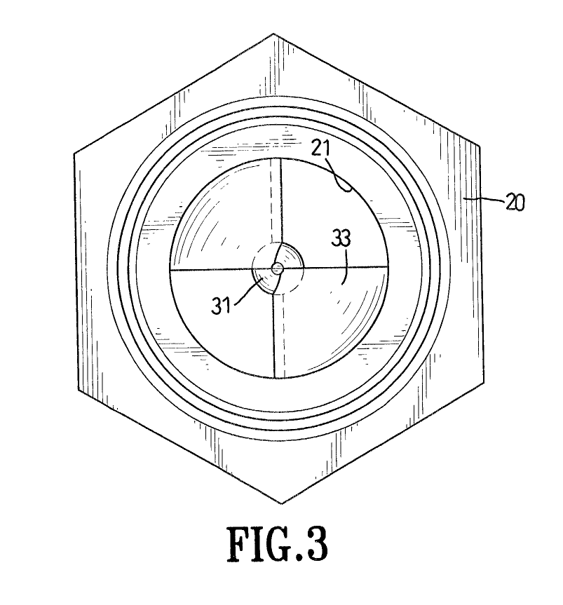

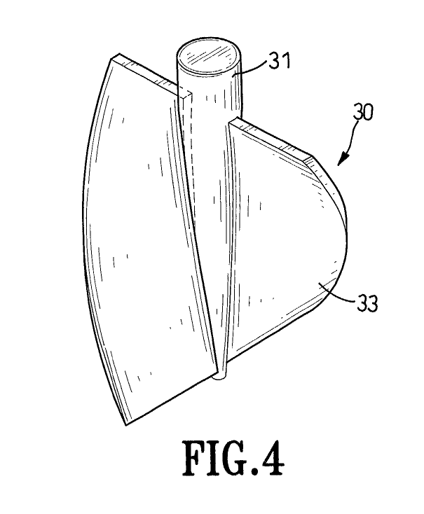

With reference to FIG. 1, a reservoir (10) has a connector (20) to connect a fluid source through a host to contain the fluid in the reservoir (10). The reservoir (10) can send out the fluid in the reservoir (10) through the same connector (20). The reservoir (10) comprises a metal shell, a plastic lining and a diaphragm as in the prior art. With reference to FIGS. 2 to 4, the connector (20) in accordance with the present invention comprises a body and a guiding member (30). The body extends through the shell and the lining of the reservoir (10). A passage (21) is defined through the body and communicates with the water chamber in the reservoir (10). The guiding member (30) comprises a post (31) and multiple spiral leaves (33). The post (31) is mounted in the passage (21) of the connector (20) and is located along an axial direction of the passage (21). One end of the post (31) extends to a conjunction of the connector (20) and the reservoir (10). The leaves (33) extend outward from the outer periphery of the post (31). The end of each leaf (33) apart from the post is connected to the inner surface of the passage (21) in the body. In practice the guiding member (30) is integrally formed with the body. In another embodiment, the connector (20) further comprises a tubular member (not shown) which is mounted around the leaves (33). An inner thread is defined in the inner surface of the passage (21), and an outer thread is formed on the outer periphery of the tubular member to screw with the inner thread in the passage (21). The guiding member can be secured to the body through the tubular member by means of the engagement of the threads.

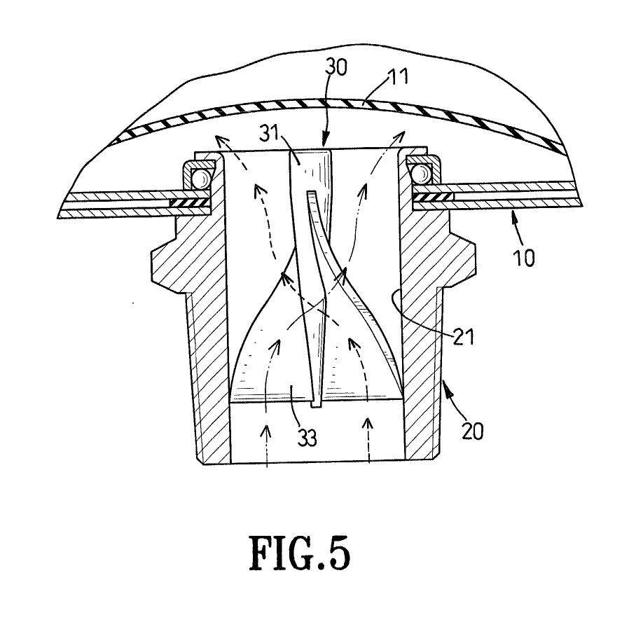

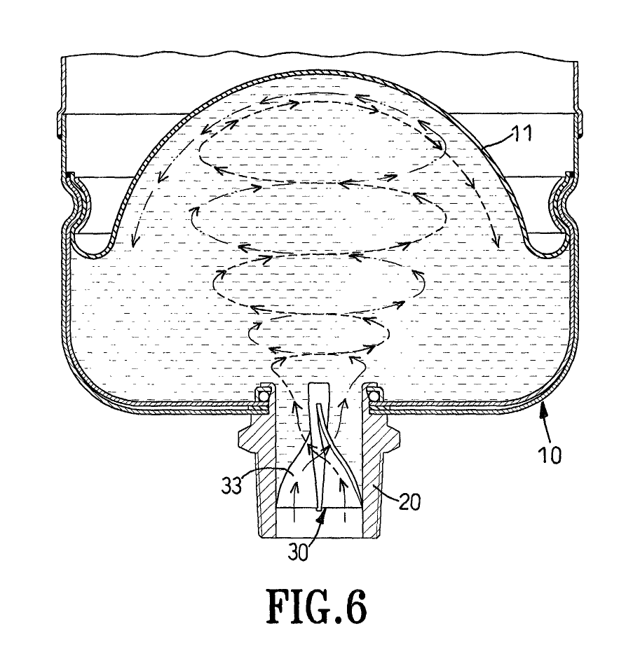

With reference to FIGS. 5 and 6, when the fluid is pumped into the reservoir (10) through the connector (20), a vortex flow will occur in the reservoir (10) as the fluid passes through the spiral leaves (33) on the guiding member (30) and the fluid in the reservoir (10) is agitated. Germs and other microorganisms do not breed easily in the agitated fluid, thus the sanitary condition of the fluid in the reservoir is improved.

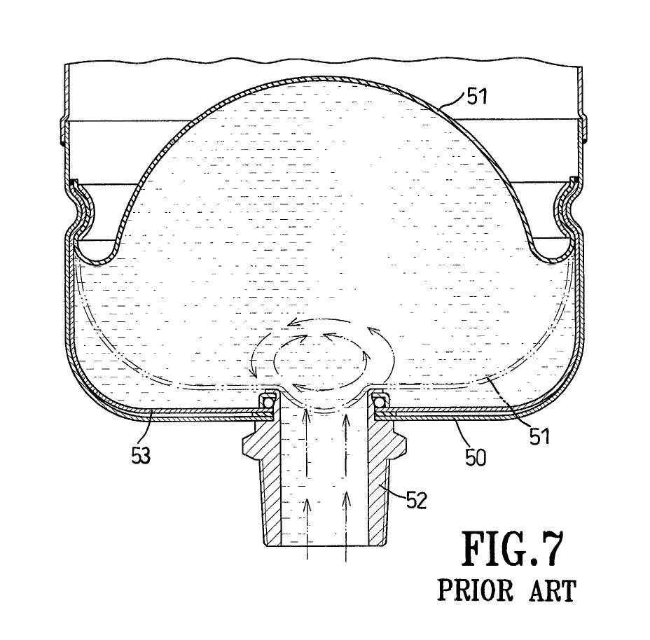

With reference to FIGS. 2 and 5, if the water chamber of the reservoir (10) is empty and the diaphragm (11) is pushed to close to the connector (20), the diaphragm (11) will abut to the post (31) in the passage (21) of the connector (20). This can avoid part of the diaphragm (11) being pushed into the passage (21) of the connector (20) as shown in the phantom lines in FIG. 7. This can ensure that the fluid can be pumped into the water chamber in the reservoir (10) through the connector (20) even if the water chamber is empty. In addition, the useful life of the diaphragm (11) is also prolonged.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector for a reservoir having a shell, a lining mounted in the shell and a diaphragm mounted below the lining to define an air cushion between the shell and the diaphragm, the connector comprising:
a body with a passage defined through the body and adapted to extend into the shell and the lining of the reservoir; and
a guiding member mounted in the passage of the body and having:
a post; and
multiple spiral leaves extending outward from an outer periphery of the post and adapted to cause a vortex flow as fluid passes through the spiral leaves.

2. The connector as claimed in claim 1, wherein each leaf has an end connected to an inner surface of the passage in the connector.

3. The connector as claimed in claim 2, wherein the guiding member is integrally formed with the body.

4. The connector as claimed in claim 1 further comprising a tubular member mounted around the leaves to attach the guiding member to the body with the tubular member,
wherein an outer thread is formed on an outer periphery of the tubular member; and
an inner thread is defined in an inner surface of the passage in the body to screw with the inner thread in the passage.
